(19) United States
(12) Patent Application Publication
(10) Pub. No.: US 2009/0106533 A1
(43) Pub. Date: Apr. 23, 2009

(54) DATA PROCESSING APPARATUS

(75) Inventor: Fumio ARAKAWA, Kodiara (JP)

Correspondence Address: MILES & STOCKBRIDGE PC, 1751 PINNACLE DRIVE, SUITE 500, MCLEAN, VA, 22102-3833, US

(73) Assignee: RENESAS TECHNOLOGY CORP.

(21) Appl. No.: 12/252,969

(22) Filed: Oct. 16, 2008

(30) Foreign Application Priority Data
Oct. 19, 2007 (JP) 2007-272466

(51) Int. Cl. G06F 9/30

(52) U.S. Cl. 712/205; 712/220; 712/E09.016

(57) ABSTRACT

The data processing apparatus includes two or more execution resources, each enabling a predetermined process for executing an instruction. The execution resources enable a pipeline process. Each execution resource treats instructions according to an in-order system following the instructions' flow order in case that the execution resource is in charge of the instructions. Also, each execution resource treats instructions according to an out-of-order system regardless of the instructions' flow order in case that the instructions are treated by different execution resources. Thus, local processes in the execution resources can be simplified and materialized in a small-scale of hardware. Consequently, the need for the whole synchronization in processing across execution resources is eliminated, and the locality of processes and the efficiency of electric power are increased.

### CLAIM OF PRIORITY

The Present application claims priority from Japanese application JP 2007-272466 filed on Oct. 19, 2007, the content of which is hereby incorporated by reference into this application.

### FIELD OF THE INVENTION

The present invention relates to a data processing apparatus such as a microprocessor, and it further relates to a technique which enables effective pipeline control.

### BACKGROUND OF THE INVENTION

In the past, data processing apparatuses including microprocessors have achieved higher performance by upsizing of circuits, leveraging a continuous rise of the number of available transistors with the advancement of scale-down of processes. As to processor architectures, the von Neumann type premised on a single instruction flow has been in the mainstream, and it has been essential for enhancement of performance to extract the highest parallelism out of a single instruction flow according to a large-scale instruction issue logic and perform processing based on it.

For example, the out-of-order system, which is common as a system for high end processors at present, includes: holding a single instruction flow in a buffer with a large capacity; checking the dependence on data for respective instructions; executing the instructions in the order in which the their requirements in connection with input data are met; and updating the condition of the processor after the execution, and again following the original instruction flow's order. At this step, a register file with a large capacity is prepared to rename the registers in order to eliminate the restriction of instruction issue owing to the antidependence of a register operand and the output dependence. Consequently, it becomes possible for a subsequent instruction to use a result of a previous execution at a time earlier than the time scheduled originally, which contributes to the enhancement of performance. However, the out-of-order system cannot be applied to the update of the processor condition. This is because if so, a basic process of a processor that a program is suspended and then resumed cannot be performed. Therefore, a result of earlier execution is stored in a reorder buffer of a large capacity, and written back into a register file or the like in the original order. As described above, the out-of-order execution of a single instruction flow is based on a system of a low efficiency, which requires a large-capacity buffer and complicated control. For example, in the non-patent document presented by R. E. Kessler, “HHE ALPHA 21264 MICROPROCESSOR”, IEEE Micro, vol. 19, no. 2, pp. 24-36, March-April 1999, 20 entries of Integer issue queues, 15 entries of Floating-point issue queues, two sets of 80 Integer register files, and 72 Floating-point register files are prepared as shown in FIG. 2 of Page 25 thereof, whereby large-scale out-of-order issues are enabled.

Other references which deal with the out-of-order system include JP-A-2004-303026 and JP-A-11-353177.

On the other hand, as to the in-order system, which is relatively smaller in logic scale, it is basic that not only the instruction issue logic but also the whole processor works in synchronism. When execution of one instruction is delayed, it is required to stop the process of a subsequent instruction regardless of the presence or absence of the dependence. For this purpose, the following is ensured: the information about the executability is collected from respective parts of the processor to judge the executability in the whole processor, and the result of the judgment is notified to the respective parts of the processor, whereby the processor works in synchronism on the whole.

An example of reference which deals with the in-order system is JP-A-2007-164354.

### SUMMARY OF THE INVENTION

In recent years, the delay coming from wiring has becoming predominant rather than the delay caused by a gate as a cause of delay in a circuit with the advancement of scale-down of processes. Hence, for speedup of logic circuits, it is required to devise a system in contemplation of wiring delay. Therefore, as to data processing apparatuses including processors, it has been becoming necessary to build up a pipeline structure most suitable for a fine process for this. A system in contemplation of wiring delay refers to, specifically, a system which can be enhanced in the locality of processes and trimmed down in the amount of information/data transfer.

In addition, the electric power has been reduced with the advancement of scale-down of processes, however it has been becoming harder to reduce the electric power because of an exponential increase of leak current involved with the miniaturization. Even when the miniaturization increases the number of transistors which can be used, the power is raised with the increase of the transistors. Therefore, the increase in power beyond the enhancement in performance lowers the efficiency of electric power when a higher performance is achieved by increasing the scale of circuits as in the past. Further, the easing of the constraint to chips in electric power, which has been going well, can not be extended beyond: 100 watts for chips used in servers, several watts for chips used in stationary embedded devices, and hundreds of milliwatts for chips in embedded devices for portable equipment. What can deliver the best performance under such constraint in electric power is a chip which is the highest in the efficiency of electric power. Hence, a system which can achieve a higher efficiency in comparison to that attained in the past is required.

However, the large-scale out-of-order system as described above can be enhanced neither in the locality of processes nor in the efficiency of electric power because it needs large-scale hardware. In addition, the in-order system is not a system in contemplation of wiring delay. This is because the in-order system requires that the processor should work in synchronism on the whole and therefore it is difficult to enhance the locality of processes. Now, it is noted that during the time of executing an instruction, the out-of-order system does not need synchronization in an entire processor as the in-order system requires, and has the locality of processes.

It is an object of the invention to materialize, for relatively small scale hardware of the in-order system, a system such as the out-of-order system, which requires no synchronization on the whole to enhance the locality of processes and increase the efficiency of electric power.

The above and other objects and novel features of the invention will be apparent from the description hereof and the accompanying drawings.

Of the embodiments herein disclosed, the preferred ones will be briefly described below.

The data processing apparatus includes execution resources (EXU, LSU) each making available a predetermined process for executing an instruction, and the execution resources enable a pipeline process. As to instructions processed by the same execution resources, the execution resources handle the instructions according to the in-order system following the order of the relevant instruction flow. For the instructions processed by different execution resources, the execution resources handle the instructions according to the out-of-order system regardless of the order of the instruction flow. Local processes in the execution resources are simplified and materialized in a small-scale of hardware by processing in this way, and thus the need for the whole synchronization in processing across execution resources is eliminated and the locality of processes and the efficiency of electric power are increased.

The effects offered by preferred one of the embodiments herein disclosed are as follows.

That is, in a relatively smaller scale of hardware like the in-order system, a system which requires no synchronization of the whole can be materialized like the out-of-order system, whereby the locality of processes can be enhanced, and the efficiency of electric power can be increased.

### BRIEF DESCRIPTION OF THE DRAWINGS

FIG. 1 is a block diagram showing an example of the configuration of a processor, which is an example of a data processing apparatus according to the invention;

FIG. 2 is an illustration for explaining a pipeline structure of a processor according to the out-of-order system;

FIG. 3 is an illustration for explaining a pipeline action in connection with a loop portion of a program run by the processor of the out-of-order system;

FIG. 4 is an illustration for explaining an action in connection with a loop portion of the program run by the processor of the out-of-order system;

FIG. 5 is an illustration for explaining an action in connection with the loop portion in case that the load latency is extended to nine from three in the example of FIG. 4;

FIG. 6 is an illustration for explaining an example of the configuration of the program;

FIG. 7 is an illustration for explaining an example of the configuration of a pipeline in the processor shown in FIG. 1;

FIG. 8 is a block diagram showing the configurations of a global instruction queue GIQ and a write information queue WIQ of the processor shown in FIG. 1;

FIG. 9 is an illustration for explaining the logic of generating a mask signal EXMSK for execution instruction;

FIG. 10 is a diagram showing a circuit for the logic of generating a mask signal EXMSK for execution instruction;

FIG. 11 is a diagram showing a circuit for the logic of generating an execution-instruction-local-select signal EXLS in the write information queue WIQ;

FIG. 12 is an illustration for explaining a pipeline action in connection with a loop portion of the program run by the processor;

FIG. 13 is an illustration for explaining an action in connection with a loop portion of the program run by the processor;

FIG. 14 is an illustration for explaining an action in connection with a loop portion in case that the load latency is extended to nine from three in the example of FIG. 13;

FIG. 15 is an illustration for explaining an action in connection with a loop portion in case that the third decrement test instruction is executed by a branch pipe, instead of being executed with an execution pipe in the example of FIG. 14;

FIG. 16 is an illustration for explaining a pipeline action, in which the antidependence and the output dependence develop;

FIG. 17 is a block diagram showing an example of other configuration of a combination of the global instruction queue GIQ and read/write information queue RWIQ of the processor shown in FIG. 1;

FIG. 18 is an illustration for explaining a pipeline action, in which the antidependence and the output dependence develop, in case of using the circuit configuration of FIG. 17.

### DETAILED DESCRIPTION OF THE PREFERRED EMBODIMENTS

### 1. Summary of the Preferred Embodiments

The preferred embodiments of the invention herein disclosed will be outlined first. Here, the reference numerals, characters or signs to refer to the drawings, which are accompanied with paired round brackets, only exemplify what the concepts of components referred to by the numerals, characters or signs contain.

[1] A data processing apparatus (10) according to a preferred embodiment of the invention includes execution resources (EXU, LSU), each making available a predetermined process for executing an instruction, and the execution resources enable a pipeline process. As to instructions processed by the same execution resources, the execution resources handle the instructions according to the in-order system following the order of the relevant instruction flow. For the instructions processed by different execution resources, the execution resources handle the instructions according to the out-of-order system regardless of the order of the instruction flow. Local processes in the execution resources are simplified and materialized in a small-scale of hardware by processing in this way, and thus the need for the whole synchronization in processing across execution resources is eliminated and the locality of processes and the efficiency of electric power are increased.

[2] The data processing apparatus includes an instruction fetch unit (IFU) which can fetch an instruction. At this time, the instruction fetch unit includes an information queue (WIQ, RWIQ) capable of checking the flow dependence, which is a cause of hazard to a preceding instruction, using register write information of the preceding instruction of a scope different for each execution resource. This changes the progress of each execution resource, which is a result of out-of-order execution, and makes it possible to check the flow dependence even under a situation that the preceding instruction is different for each execution resource.

[3] The information queue exercises control so that register read of a preceding instruction is never passed by register write of a subsequent instruction. Specifically, the number of read register of the preceding instruction is checked before register write of the subsequent instruction, and when the relation of antidependence is detected, register write of the subsequent instruction is delayed, and register read of the preceding instruction is put ahead. Thus, the consistency of results of execution of instructions in the relation of antidependence is maintained.

[4] A local register file can be disposed for each of the execution resources. This makes it possible to ensure the locality of register read.

[5] The register write is performed on only a local register file corresponding to the execution resource which reads out the written value. This eliminates the need for checking antidependence and reduces the power consumption.

[6] The execution resource includes an execution unit which allows processing of data, and a load-store unit which enables loading and storing of data based on the instruction. In this case, a local register file for the execution instruction and a local register file for the load/store instruction may be set as the local register files. To ensure the locality of register read, the local register file for an execution instruction is placed in the execution unit, and the local register file for a load/store instruction is placed in the load-store unit.

[7] The consistency of results of execution of instructions in the relation of output dependence may be maintained by exercising control so that register write of a preceding instruction is never passed by register write of a subsequent instruction.

[8] In the case where register write of a preceding instruction has been passed by register write of a subsequent instruction targeting the same register, the consistency of results of execution of instructions in the relation of output dependence may be maintained by inhibiting register write of the preceding instruction.

### 2. Further Detailed Description of the Preferred Embodiments

Next, the embodiments will be described further in detail.

### <<Examples for Comparison to the Embodiments>>

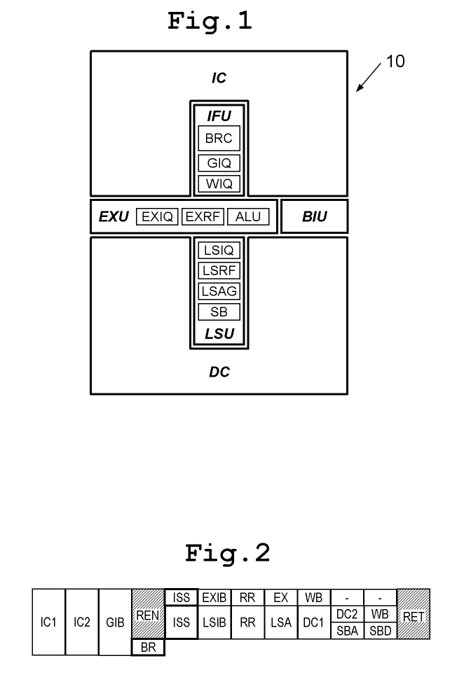

Here, the structure, action and other features of a conventional processor, which makes an example for comparison to the embodiments, will be described with reference to FIGS. 1, 2 and 6 first.

FIG. 6 exemplifies a first program for explaining an example of the action of the processor.

The first program is a program which adds up two arrays a[i] and b[i], each having N elements, and stores the result in an array c[i], as written in C language in FIG. 6A. Now, the first program converted into the form of an assembler will be described. Assembler programs are predicated on an architecture with load and store instructions of post-increment type.

As shown in FIG. 6B, head addresses_a, _b and _c of three arrays, and the number N of elements of the arrays are stored, as initial settings, in the registers r0, r1, r2 and r3 according to four immediate-value-transfer instructions “mov #_a, r0”, “mov #_b, r1”, “mov #_c, r2” and “mov #_N, r3” respectively. Next, in the loop portion, according to post-increment load instructions “mov @r0+, r4” and “mov @r1+, r5”, array elements are loaded into the registers r4 and r5 from the addresses of the arrays a and b indicated by the registers r0 and r1, and concurrently the registers r0 and r1 are incremented so as to indicate subsequent array elements. Next, according to the decrement test instruction “dt r3”, the number N of elements stored in the register r3 is decremented. Then, a test on whether or not the result is zero is performed. When the result is zero, a flag is set, and otherwise the flag is cleared. After that, according to the add instruction “add r4, r5”, the array elements loaded into the registers r4 and r5 are added together, and the result is stored in the register r5. Then, according to the post-increment store instruction “mov r5, @r2+”, the value of the register r5, which is the result of addition of the array elements, is stored at an element address of the array c. Finally, according to the conditional branch instruction “bf _L00”, the flag is checked. When the flag has been cleared, the remaining element number N has not reached zero yet, and therefore the flow of the processing branches to the beginning of the loop indicated by the label _L00.

FIG. 2 schematically exemplifies the pipeline structure of processors of out-of-order system.

The structure is constituted by: stages of instruction cache accesses IC1 and IC2, and a stage of a global instruction buffer GIB, which are common to all instructions; a stage of register renaming REN and a stage of instruction issue ISS, which are for execution instruction and load/store instruction; a stage of local instruction buffer EXIB, a stage of register read RR, a stage of execution EX, which are for execution instruction; a stage of local instruction buffer LSIB, a stage of register read RR, a stage of load and store address calculations LSA, a stage of data cache access DC1, which are for load/store instruction; a data cache access second stage DC2 for a load instruction; stages of store buffer address and data write SBA and SBD for a store instruction; a stage of branch BR for a branch instruction; a stage of physical register write back WB common to instructions including a register write back action; and a stage of instruction retire RET owing to write back to a logical register. The result of update of the address register by post increment is written back into a physical register in the stage of data cache access DC1 after the stage of address calculation LSA. The instruction fetch is carried out in sets of four instructions. As for instruction issue, one instruction can be issued in each cycle according to the categories of load/store, execution and branch.

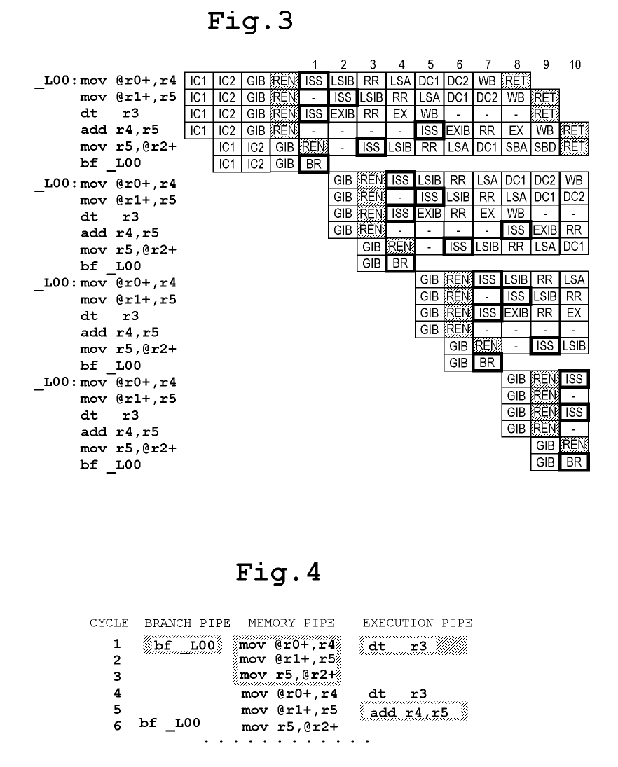

FIG. 3 exemplifies the pipeline action in connection with the loop portion in case that a processor of the out-of-order system having the pipeline structure as exemplified by FIG. 2 runs the first program.

In execution of the load instruction “mov @r0+, r4” at the beginning, the instruction is carried out through the respective processes in the stages of instruction cache access IC1 and IC2, the stage of global instruction buffer GIB, the stage of register renaming REN of the stage of instruction issue ISS, the stage of local instruction buffer LSIB, the stage of register read RR, the stage of address calculation LSA, stages of data cache access DC1 and DC2, the stage of physical register write back WB, and the stage of instruction retire RET. In execution of the second load instruction “mov @r1+, r5”, the second load instruction competes with a preceding load instruction for a resource and as such, one cycle of a bubble stage is generated after the stage of register renaming REN. However, in the other stages after that, the second instruction is processed in the same way as the load instruction at the beginning is handled. In execution of the third decrement test instruction “dt r3”, the instruction is processed in the same way as the first load instruction is treated until the stage of instruction issue ISS. After that, processes of the stage of local instruction buffer EXIB, the stage of register read RR, the stage of execution EX and the stage of physical register write back WB are performed. Then, four cycles of bubble stages are inserted for the purpose of restoring the contextual relation with the preceding instructions, and thereafter the process of the stage of instruction retire RET is carried out. In execution of the fourth add instruction “add r4, r5”, four cycles of bubble stages are generated after the stage of register renaming REN because of the flow dependence in connection with the two preceding load instructions. Then, the instruction is carried out through the processes of the stage of instruction issue ISS, the stage of local instruction buffer EXIB, the stage of register read RR, the stage of execution EX, the stage of physical register write back WB, and the stage of instruction retire RET. In execution of the fifth post-increment store instruction “mov r5, @r2+”, as the instruction fetch is performed in sets of four instructions, a cycle of pipeline bubble is generated after the stages of instruction cache accesses IC1 and IC2, the stage of global instruction buffer GIB and the stage of register renaming REN, which are delayed by one cycle behind the four preceding instructions because of the contention with the preceding load instructions for a resource. After that, the instruction is executed through the processes of the stage of instruction issue ISS, the stage of local instruction buffer LSIB, the stage of register read RR, the stage of address calculation LSA, the stage of data cache access DC1, the stages of store buffer address and data write SBA and SBD and the stage of instruction retire RET. When an attempt to read the register r5 is made in the stage of register read RR, the processor is forced to wait because of the flow dependence, however the processor is never kept waiting if it receives the content of the register in the stage of store buffer data write SBD. In execution of the conditional branch instruction “bf _L00” at the end of the loop, the instruction is processed in the stage of branch BR right after the stage of global instruction buffer GIB. As all instructions can be held in the global instruction queue GIQ with a small loop that six instructions are handled in each loop, the branching process is achieved by repeatedly executing instructions corresponding to one loop, which have been held in the global instruction queue GIQ. Thus, right after the BR stage, the process of the stage of global instruction queue GIQ of the loop head instruction “mov @r0+, r4”, which is an instruction at a branch destination, is carried out.

As a result of the action as described above, the number of cycles from the stage of register renaming REN to the stage of retire RET in execution of each instruction reaches 9 to 11. During this period, a different physical register is allocated each time of register write, and the process of the loop is started every three cycles, and therefore the physical register used for the first loop is released in the middle of the fourth loop. Further, the logical register R5 is subjected to write backs by the second load instruction and fourth add instruction. Therefore, two physical registers are allocated for the register R5 in one loop. Consequently, the number of physical registers required for mapping six logical registers is seven per loop, and different physical registers are needed for first to fourth loops, and therefore the total number of required physical registers is 28.

Now, FIG. 4 exemplifies the action in connection with the loop portion in case of running the first program on a processor of the out-of-order system. The ordinal number of an execution cycle of each instruction is based on the stage of instruction issue ISS or branch BR of the pipeline action as exemplified in FIG. 2. As to a load instruction, the three stages, i.e. the stage of address calculation LSA, and the stages of data cache access DC1 and DC2 are counted in as a latency; with a branch instruction, the three stages of branch BR, global instruction buffer GIB and register renaming REN are counted in as a latency. Therefore, the latencies of load and branch instructions are 3. Initially, in the first cycle, the load instruction “mov @r0+, r4” at the beginning, the third decrement test instruction “dt r3” and the conditional branch instruction “bf _L00” at the end of the loop are executed. In the second cycle, the second load instruction “mov @r1+, r5” is executed. In the third cycle, the fifth post-increment store instruction “mov r5, @r2+” is conducted. Then, in the fourth cycle, the process of the second loop is started, and the action is the same as that of the first cycle. In the fifth cycle, the fourth add instruction “add r4, r5” of the first loop and the second load instruction “mov @r1+, r5” of the second loop are executed. The sixth cycle is the same as the third cycle in action. After that, the actions of three cycles are repeated in each loop.

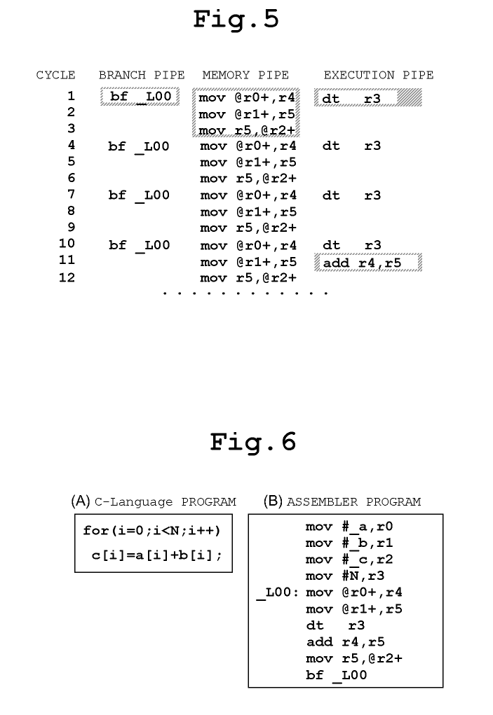

FIG. 5 exemplifies the action in connection with the loop portion in the case of extending the load latency to 9 from 3 of FIG. 4. It is realistic to assume a long latency because it is difficult to hold a large volume of data in a high-speed and small-capacity memory. With an increase in load latency, the point of starting execution of the fourth add instruction “add r4, r5” is delayed by six cycles in comparison to the case of FIG. 4. Consequently, the number of cycles from the stage of register renaming REN to the stage of retire RET is 15-17, which is longer than the case of FIG. 3 by six cycles. The physical register is released in the middle of the sixth loop. Therefore, the number of physical registers required for mapping six logical registers is increased, by 14 corresponding to two loops, to a total of 42. As described above, with the conventional out-of-order system, the number of required physical registers is approximately 4-7 times the number of the logical registers, even though it depends on the program and execution latency.

### EMBODIMENT

FIG. 1 schematically exemplifies the arrangement of blocks of a processor, which is an example of the data processing apparatus according to the invention.

The processor 10 shown in FIG. 1 is not particularly limited. However, it includes: an instruction cache IC; an instruction fetch unit IFU; a data cache DC; a load-store unit LSU; an execution unit EXU; and a bus interface unit BIU. The instruction fetch unit IFU is laid out in the vicinity of the instruction cache IC, and includes a global instruction queue GIQ for receiving an fetched instruction first, a branch process control part BRC, and a write information queue WIQ for holding and managing register write information created from an instruction latched in the global instruction queue GIQ until the register write is completed. In the vicinity of the data cache DC, the load-store unit LSU is laid out, which includes a load/store instruction queue LSIQ for holding load/store instructions, a local register file LSRF for load/store instruction, an address adder LSAG for load/store instruction, and a store buffer SB for holding an address and data of a store instruction. Further, the execution unit EXU includes an instruction execution queue EXIQ for holding an execution instruction, a local register file EXRF for an execution instruction, and an arithmetic logical unit ALU for execution instruction. The bus interface unit BIU functions as an interface between the processor 10 and an external bus.

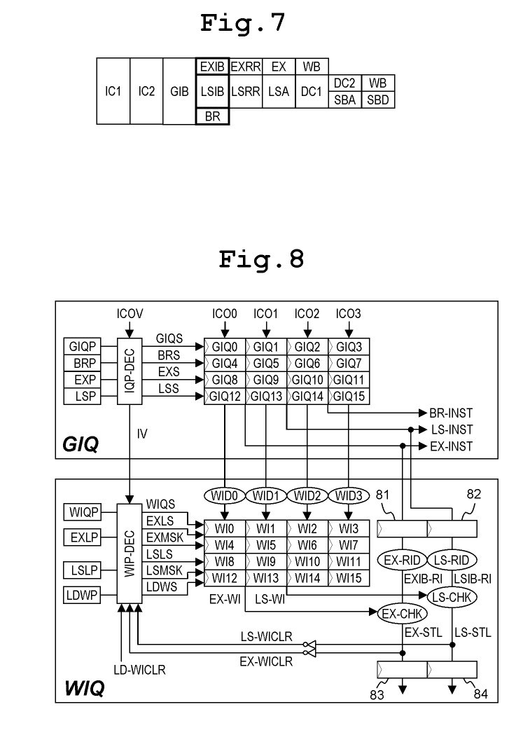

FIG. 7 exemplifies the structure of the pipeline of the processor 10 schematically.

The pipeline structure includes stages of instruction cache access IC1 and IC2 and a stage of global instruction buffer GIB, which are common to all instructions, and a stage of local instruction buffer EXIB, a stage of local register read EXRR and a stage of execution EX for execution instruction. Provided for load/store instruction are a stage of local instruction buffer LSIB, a stage of local register read LSRR, a stage of address calculation LSA and a stage of data cache access DC1. There are a data cache access second stage DC2 for a load instruction, and stages of store buffer address and data write SBA and SBD for a store instruction. Further, a stage of branch BR for a branch instruction, and a stage of register write back WB common to instructions including a register write back action are prepared.

In the stages of instruction cache access IC1 and IC2, the instruction fetch unit IFU fetches instructions in sets of fours from the instruction cache IC, and stores them in the global instruction queue GIQ of the stage of global instruction buffer GIB. The stage of global instruction buffer GIB produces, from instructions thus stored, register write information, and stores the information in the write information queue WIQ in the subsequent cycle. Instructions belonging to the categories of load/store, execution and branch are extracted one at a time, and they are respectively stored in the instruction queue LSIQ of the load-store unit LSU, the instruction queue EXIQ of the execution unit EXU, and the branch control part BRC of the instruction fetch unit IFU in the stages of local instruction buffer LSIB and EXIB and the stage of branch BR. Then, in the stage of branch BR, the branching process is started on receipt of a branch instruction.

According to the pipeline for execution instruction, in the stage of local instruction buffer EXIB, the execution unit EXU receives execution instructions in the instruction queue EXIQ with a rate of up to one instruction per cycle, and decodes at most one instruction at a time, whereas the instruction fetch unit IFU checks the write information queue WIQ to detect whether or not an instruction in the course of decoding depends on a register associated with a preceding instruction. In the next stage of local register read EXRR, the register read is performed when no dependence on the register is detected, and the stage is stalled to generate a pipeline bubble when such dependence is detected. After that, the arithmetic logical unit ALU is used to perform an data processing in the stage of execution EX, and the result is stored in a register in the stage of register write back WB.

According to a pipeline for load/store instruction, in the stage of local instruction buffer LSIB, the load-store unit LSU receives a load/store instruction in the instruction queue LSIQ with a rate of up to one instruction per cycle, and decodes at most one instruction at a time, whereas the instruction fetch unit IFU checks the write information queue WIQ to detect whether or not an instruction in the course of decoding depends on a register associated with a preceding instruction. In the next stage of local register read LSRR, the register read is performed when no dependence on the register is detected, and the stage is stalled to generate a pipeline bubble when such dependence is detected. After that, in the stage of address calculation LSA, the address adder LSAG is used to perform an address calculation. In case that the received instruction is a load instruction, data is loaded from the data cache DC in the stages of data cache access DC1 and DC2, and data is stored in a register in the stage of register write back WB. In case that the received instruction is a store instruction, an access exception check and a hit-or-miss judgment on the data cache DC are performed in the stage of data cache access DC1, and a store address and store data are written into the store buffer in the stages of store buffer address and data write SBA and SBD respectively.

FIG. 8 exemplifies the structures of the global instruction queue GIQ and write information queue WIQ in the processor 10.

As shown in FIG. 8, the global instruction queue GIQ includes: instruction queue entries GIQ0-15 corresponding to sixteen instructions;

a global instruction queue pointer GIQP which specifies a write position; an execution instruction pointer EXP; a load/store instruction pointer LSP; and a branch instruction pointer BRP, which are set forward with the progress of instructions belonging to the categories of execution, load and store, and branch, respectively, and specify read positions; and an instruction queue pointer decoder IQP-DEC which decodes the pointers.

On the other hand, the write information queue WIQ includes: write information decoders WID0-3; write information entries WI0-15 corresponding to sixteen instructions; a write information queue pointer WIQP which specifies a new write information set position; a load/store instruction local pointer LSLP which specifies the positions of execution instruction and load/store instruction in local instruction buffer stages EXIB and LSIB; an execution instruction local pointer EXLP; a load data write pointer LDWP which points at an instruction for loading load data to be made available subsequently; and a write information queue pointer decoder WIP-DEC.

According to a global-instruction-queue-select signal GIQS produced as a result of decode by the global instruction queue pointer GIQP, the global instruction queue GIQ latches four instructions ICO0-3 fetched from the instruction cache IC into the instruction queue entries GIQ0-3, GIQ4-7, GIQ8-11 or GIQ12-15, and outputs the latched four instructions to the write information decoders WID0-3 of the write information queue WIQ with a cycle right after the latch. Incidentally, the global instruction queue GIQ receives an instruction-cache-output-validity signal ICOV showing the validity of the fetched four instructions ICO0-3 concurrently. If the signal is asserted, the signal is latched in the global instruction queue GIQ. Further, according to an execution-instruction-select signal EXS, a load/store-instruction-select signal LSS, and a branch-instruction-select signal BRS, which are produced as a result of decode of the three pointers, i.e. the execution instruction pointer EXP, the load/store instruction pointer LSP and branch instruction pointer BRP, one instruction is extracted for each category, and the instructions thus extracted are output as an execution instruction EX-INST, a load/store instruction LS-INST and a branch instruction BR-INST.

In the write information queue WIQ, the write information decoders WID0-3 receive four instructions latched by the global instruction queue GIQ to produce register write information of the instructions, first. Then, if the validity signal IV in connection with the received instructions has been asserted, the produced register write information is latched in the write information entries WI0-3, WI4-7, WI8-11 or WI12-15 according to a write-information-queue-select signal WIQS produced as a result of decode of the write information queue pointer WIQP. The write information queue pointer WIQP points at the oldest instruction of the instructions latched by the write information queue WIQ. Therefore, when the register write information of four instructions is regarded as being unnecessary based on this oldest instruction, and erased, empty spaces are created in the write information queue WIQ and thus it becomes possible to latch write information in connection with new four instructions. After new write information has been newly latched, the write information queue pointer WIQP is set forward so as to point at subsequent four entries.

In contrast, the execution instruction local pointer EXLP and the load/store instruction local pointer LSLP point at an instruction which will be executed next. From the oldest instruction to the instruction right before the instruction specified by the pointers make instructions preceding the instruction which will be executed next, which are treated as instructions targeted for check on the flow dependence. Then, the write information queue pointer decoder WIP-DEC produces mask signals EXMSK and LSMSK for execution instruction and load/store instruction from the write information queue pointer WIQP, and the execution and load/store instructions' local pointers EXLP and LSLP; the mask signals are for selecting all entries within a range targeted for the check on the flow dependence.

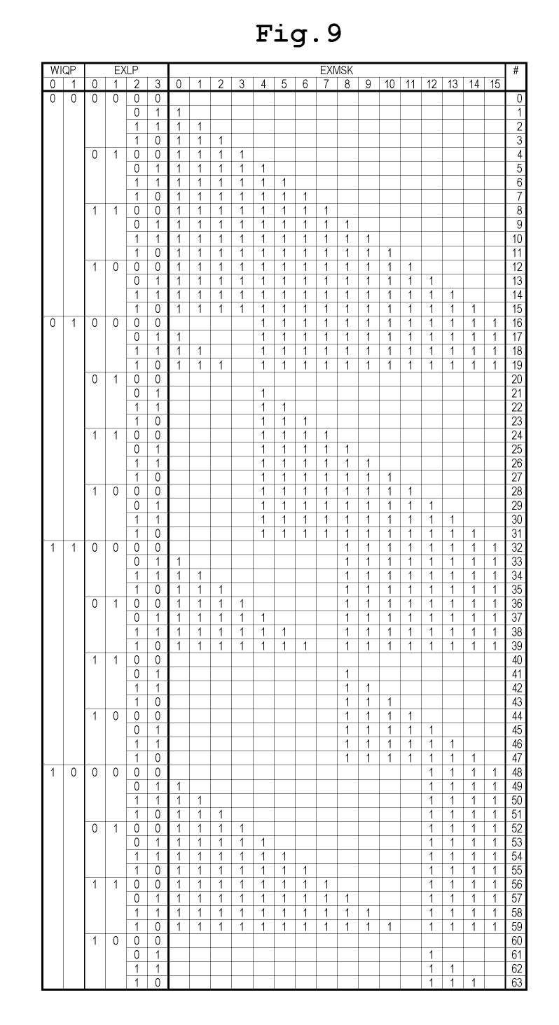

FIG. 9 exemplifies the logic of generating the mask signal EXMSK for the execution instruction.

The input signal is constituted by a total of six bits composed of two bits of the write information queue pointer WIQP, and four bits of the execution instruction local pointer EXLP. In regard to the output, the mask signal EXMSK for the execution instruction corresponding to the write information entries WI0-15 for 16 instructions is constituted by 16 bits. To facilitate decoding, the pointer is renewed in couples of bits in the order of 00, 01, 11 and 10 cyclically. As one of two bits of each couple can indicate whether or not the number is adjacent one, it can be said that this is encoding suitable to produce signals within a given range. However, the write information queue pointer WIQP is set forward at every fourth bit, and therefore in cases of 00, 01, 11 and 10, the pointer pints at the entries 0, 4, 8 and 12 respectively. Further the execution instruction local pointer EXLP points at only an execution instruction, and goes ahead skipping other instructions.

The rightmost column contains numerals assigned to 64 output signal values. To make the table more legible, as to the mask signal EXMSK for execution instruction, only in the cells corresponding to bits taking a value of one(1), “1” is written, otherwise nothing is entered. With the signal value pattern assigned #0, it is shown that there is no preceding instruction because the two pointers are identical showing “0”, and the bits of the mask signal EXMSK for execution instruction take all “0”. In case that the execution instruction local pointer EXLP is incremented as shown by the signal value patterns assigned #2-#15 with the write information queue pointer WIQP left holding “0”, the number of preceding instructions is increased, and accordingly the mask signal EXMSK for execution instruction is asserted. Likewise, as to the signal value pattern assigned #20, there is no preceding instruction because both the two pointers are identical showing “4”. In case that the execution instruction local pointer EXLP is incremented and made to wrap around on the way as shown by the signal value patterns assigned #21-#31 and #16-#19 with the write information queue pointer WIQP left holding “4”, the number of preceding instructions is increased, and accordingly the mask signal EXMSK for execution instruction is asserted. This applies to the signal value patterns assigned the numerals after #32. Now, it is noted that the logic of generating the mask signal LSMSK for load/store instruction from the write information queue pointer WIQP and the load/store instruction local pointer LSLP is the same.

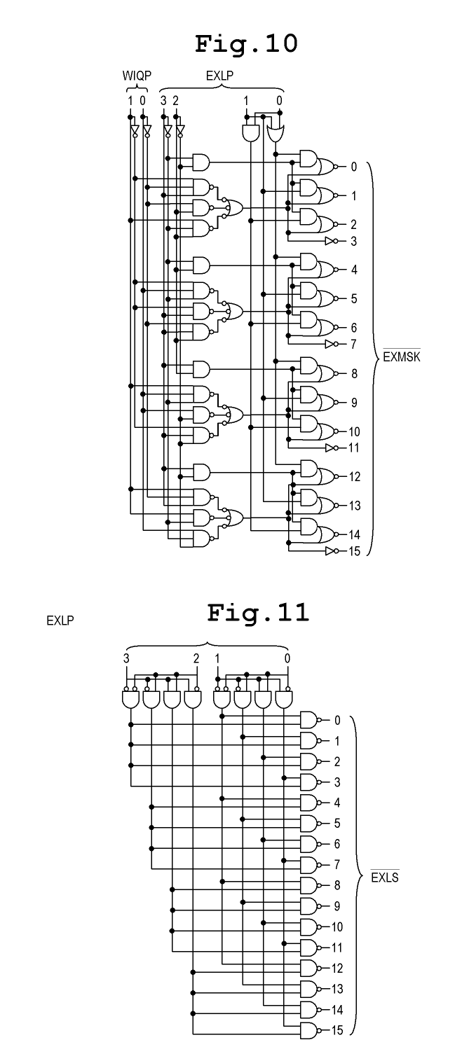

The logic of generating the mask signal EXMSK for execution instruction seems complicated at first glance as described above. However, the logic circuit is as shown in FIG. 10, for example, and a small-scale logic with 50 gates in terms of two-input NANDs suffices as such circuit. Now, it is noted that the bar over the reference sign EXMSK shows that the signal has been logically inverted. For the sake of comparison, the logic of a 4-bit decoder which produces an execution-instruction-local-select signal EXLS from the execution instruction local pointer EXLP is exemplified by FIG. 11; the logic circuit is equivalent to 28 gates in terms of two-input NANDs. Such 4-bit decoders are used everywhere in a control part. However, the logic of generating a mask signal as described above is applied to only two sites, which builds up a logic scale that no special problem is posed.

According to the mask signal EXMSK for execution instruction produced in the way as described above, the write information of an instruction preceding the execution instruction which the execution instruction local pointer EXLP points at is taken out of the 16 entries of the write information queue WIQ as shown in FIG. 8 to work out a logical sum, and outputs the result as write information EX-WI for execution instruction. Likewise, according to the mask signal LSMSK for load/store instruction, the write information of an instruction preceding the load/store instruction which the load/store instruction local pointer LSLP points at is taken out of the 16 entries of the write information queue WIQ to work out a logical sum, and outputs the result as a write information LS-WI for load/store instruction.

Concurrently, in the stage of global instruction buffer GIB, the execution instruction EX-INST and load/store instruction LS-INST output from the global instruction queue GIQ are latched by latches 81 and 82. In the stages of local instruction buffer LSIB and EXIB, the instructions thus latched are synchronized and input to register read information decoders EX-RID and LS-RID for execution instruction and load/store instruction to decode them. Thus, the pieces of the register read information EXIB-RI and LSIB-RI of execution instruction and load/store instruction are produced. Then, logical products of write information EX-WI and LS-WI and read information EXIB-RI and LSIB-RI are worked out according to register numbers, and the resultant products are added up into logical sums with respect to all the register numbers. The resultant logical sums are used as issue stalls EX-STL and LS-STL of execution instruction and load/store instruction respectively. The issue stalls EX-STL and LS-STL are output through latches 83 and 84.

On negation of such issue stalls, instructions are issued. This embodiment is based on the assumption that the operation of execution instruction and the address calculation of load/store instruction are finished in one cycle. Therefore, when an execution instruction and a load/store instruction are issued, the results can be used for instructions issued in subsequent cycles. Hence, on issue of an instruction, corresponding register write information in the write information queue WIQ is cleared. The signals resulting from negate of the issue stalls EX-STL and LS-STL of execution instruction and load/store instruction are used as register-write-information-clear signals EX-WICLR and LS-WICLR of execution instruction and load/store instruction respectively. On the other hand, the latency of the load instruction is three, and therefore the corresponding register write information is cleared after a lapse of two cycles typically. However, a lapse of three or more cycles can be required owing to e.g. cache miss before it is allowed to use load data. Hence, the corresponding register write information is cleared by inputting a load-data-register-write-information-clear signal LD-WICLR at the time when the load data is actually made available.

For example, an instruction to update two registers is possible like the post-increment load instruction “mov @r0+, r4” of the program as shown in FIG. 6. In this case, pieces of write information of both the address register r0 and load-data register r4 are stored in entries for one instruction. Both the two registers are made available at different times, i.e. when one cycle has elapsed and when three cycles have elapsed after instruction issue. On this account, clearing of register write information of the register r0 according to the load/store instruction's register-write-information-clear signal LS-WICLR in connection with a load instruction is performed selectively depending on the register number, and register write information of the load-data register r4 is left. In contrast, at the time of clearing the register write information of the register r4 according to the load-data-register-write-information-clear signal LD-WICLR, other register write information has been cleared and as such, selective clearing depending on the register number is not required, and all the register write information of entries for a load instruction are cleared.

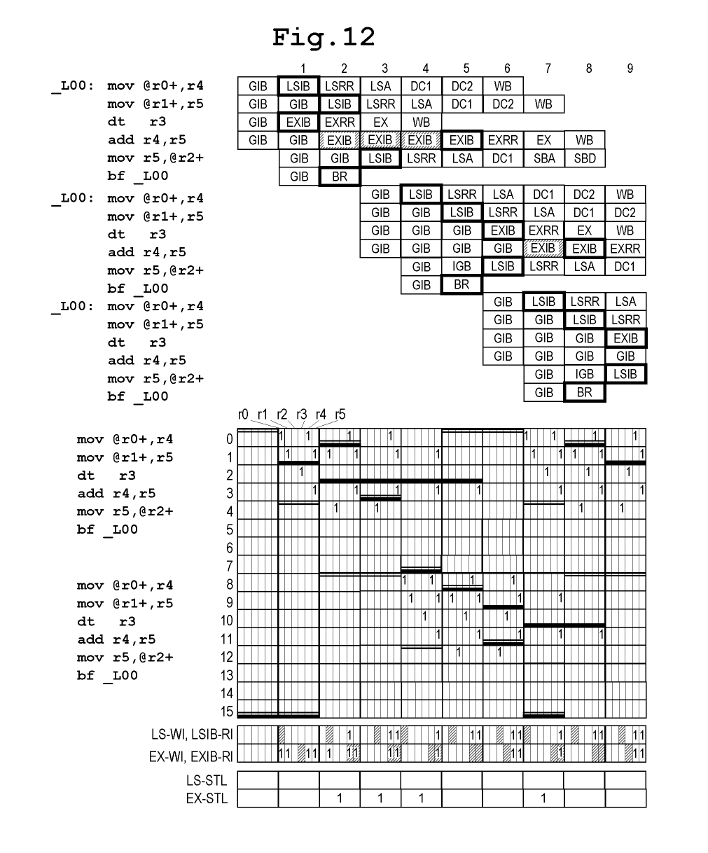

FIG. 12 exemplifies the pipeline action of the processor 10 according to the program shown in FIG. 6.

The statement is started with an action in connection with the stage of global instruction buffer GIB, and the instructions involved with the stages of the instruction cache access IC1 and IC2 are omitted here. First, the top load instruction “mov @r0+, r4” is executed through the processes in the stages of global instruction buffer GIB, local instruction buffer LSIB, local register read LSRR, address calculation LSA, data cache access DC1 and DC2, and register write back WB.

The second load instruction “mov @r1+, r5” is held in the stage of global instruction buffer GIB for two cycles and then processed in the same way as the first load instruction because the instruction interferes with the preceding load instruction in resource.

The third decrement test instruction “dt r3” is executed through processes in the stages of global instruction buffer GIB, local instruction buffer EXIB, local register read EXRR, execution EX, and register write back WB.

The fourth add instruction “add r4, r5” is held in the stage of global instruction buffer GIB for two cycles and then entered into the stage of local instruction buffer EXIB because the instruction interferes with the preceding decrement test instruction in resource. After that, the instruction is stalled for three cycles in the stage of local instruction buffer EXIB before executed through the processes in the stages of local register read EXRR, execution EX and register write back WB because of the flow dependence in connection with the two preceding load instructions.

The fifth post-increment store instruction “mov r5, @r2+” is entered into the stage of global instruction buffer GIB one cycle behind the preceding instruction because instruction fetch is carried out in four instructions. After that, the instruction is held in the stage of global instruction buffer GIB for two cycles, and then executed through the processes in the stages of local instruction buffer LSIB, local register read LSRR, address calculation LSA, and data cache access DC1, and the stages of store buffer address and data write SBA and SBD because the instruction interferes with the preceding load instruction in resource.

The conditional branch instruction “bf _L00” at the end of the loop is executed by the processes in the stages of global instruction buffer GIB and branch BR. The branching process is conducted by repeatedly executing the instructions of one loop held in the global instruction queue GIQ as in the case of the processor according to the out-of-order system mentioned before. Thus, the stage of global instruction queue GIQ in connection with the loop head instruction “mov @r0+, r4”, which is the instruction at the branch destination, is executed just after the BR stage.

The second loop is executed three cycles behind the first loop. However, in cases of executing the third decrement test instruction “dt r3” and the fourth add instruction “add r4, r5”, the third and fourth instructions are held in the stage of global instruction buffer GIB for a longer time than the first loop by additional two cycles because the instructions interfere with the fourth add instruction “add r4, r5” of the first loop in resource. Consequently, this reflects to the execution of the third decrement test instruction “dt r3”, and the execution is delayed by additional two cycles. As to the fourth add instruction “add r4, r5”, stall owing to the flow dependence is reduced by two cycles, whereby the redundant cycles are balanced out, and the fourth instruction is executed three cycles behind the fourth instruction of the first loop as in the cases of the other instructions. In and after the third loop, the instructions are executed as in the case of the instructions of the second loop.

Now, the action of checking the flow dependence at each instruction issue will be described.

The state of the write information queue WIQ in each cycle is exemplified in FIG. 12.

In the example six registers r0 to r5 are used, and therefore the description concerning the actions in connection with the six registers is presented. In the drawing, only in the cells corresponding to bits taking a value of one(1), “1” is written, otherwise nothing is entered as in the case of FIG. 9. In the drawing, a double thin line represents an entry which the write information queue pointer WIQP points at; a thick line represents the entry right before an entry which the execution instruction local pointer EXLP points at; and a double line constituted by thin and thick lines represents the entry right before an entry which the load/store instruction local pointer LSLP points at. Therefore, entries in the range of from the double thin line to the thick line are targeted for check on the flow dependence in connection with an execution instruction, and entries in the range of from the double thin line to the double line constituted by thin and thick lines are targeted for check on the flow dependence in connection with a load/store instruction. Now, in case that a double thin line is in a lower position, the range is wrapped around to the entry #0 just after the entry #15.

With the states of the write information EX-WI and LS-WI for execution instruction and load/store instruction, as in the case of FIG. 9, only in the cells corresponding to bits taking a value of one(1), “1” is written, otherwise nothing is entered. As to the read information EXIB-RI and LSIB-RI for execution instruction and load/store instruction, registers to be checked on the flow dependence are shown, and the cells corresponding to the asserted registers are hatched. Therefore, when a hatched area contains “1”, the flow dependence develops, and thus pipeline stall is required. Therefore, the issue stalls EX-STL and LS-STL for execution instruction and load/store instruction are asserted.

Initially, in the stage of global instruction buffer GIB, the first four instructions are latched in the global instruction queue GIQ and sent to the write information queue WIQ. In parallel, the top instruction is sent to the stage of local instruction buffer LSIB as the load/store instruction LS-INST of FIG. 8, and the third instruction is sent to the stage of local instruction buffer EXIB as the execution instruction EX-INST. At this time, the write information queue WIQ is empty, and the write information queue pointer WIQP, execution instruction local pointer EXLP, and load/store instruction local pointer LSLP point at the first entry WI0.

In the subsequent cycle, the register write information of the first four instructions is latched in the first four entries WI0-WI3 of the write information queue WIQ, and the write information queue pointer WIQP points at the entry WI4. The execution instruction local pointer EXLP points at the entry WI2. The load/store instruction local pointer LSLP remains pointing at the top entry WI0. As a result, the write information EX-WI for execution instruction is asserted with respect to the registers r0, r1, r4 and r5, and the write information LS-WI for load/store instruction is not asserted as in FIG. 12. Further, the read information EXIB-RI and LSIB-RI for execution instruction and load/store instruction is asserted for the registers r0 and r3. As there is no overlap in register number, the issue stalls EX-STL and LS-STL of execution instruction and load/store instruction are not asserted.

In the subsequent cycle, the register write information of the register r0 of the entry WI0 and the register r3 of the entry WI2, which is made available by execution of the first and third instructions, is cleared. The write information of the fifth post-increment store instruction “mov r5, @r2+” is newly latched in the entry WI4. Incidentally, the sixth conditional branch instruction “bf _L00” includes no register write action. Further, the seventh and eighth instructions are out-of-loop instructions, which remain nontarget for the check and are canceled by branching. No matter what statement is written therein, it has no effect on the action. Hence, the corresponding entries WI6 and WI7 are left empty for the sake of simplicity. Further, the write information queue pointer WIQP points at the entry WI8. The execution instruction local pointer EXLP points at the entry WI3. The load/store instruction local pointer LSLP points at the entry WI1. As a result, as in the drawing, the write information EX-WI for execution instruction is asserted with respect to the registers r1, r4 and r5, and the write information LS-WI for load/store instruction is asserted with respect to the register r4. Further, the read information EXIB-RI for execution instruction is asserted for the registers r4 and r5, and the read information LSIB-RI for load/store instruction is asserted for the register r1. As the write information EX-WI for execution instruction overlaps with the read information EXIB-RI for execution instruction, the execution-instruction-issue stall EX-STL is asserted. Then, this signal stalls the stage of local instruction buffer EXIB.

In the subsequent cycle, the register write information of the register r1 of the entry WI1, which is made available by execution of the second instruction, is cleared. The write information queue pointer WIQP still remains pointing at the entry WI8. The execution instruction local pointer EXLP also still remains pointing at the entry WI3. The load/store instruction local pointer LSLP points at the entry WI4. As a result, as in FIG. 12, both the write information EX-WI for execution instruction, and write information LS-WI for load/store instruction are asserted with respect to the registers r4 and r5. In addition, the read information EXIB-RI for execution instruction is asserted for the registers r4 and r5, and the read information LSIB-RI for load/store instruction is asserted for the register r2. As the write information EX-WI for execution instruction overlaps with the read information EXIB-RI for execution instruction, the execution instruction, and issue stall EX-STL are asserted. Then, this signal stalls the stage of local instruction buffer EXIB.

In the subsequent cycle, the register write information of the register r2 of the entry WI4, which is made available by execution of the fifth instruction, is cleared. The register write information of the first four instructions of the second loop is latched in the four entries WI8-WI11 of the write information queue WIQ. The write information queue pointer WIQP points at the entry WI12. The execution instruction local pointer EXLP still remains pointing at the entry WI3. The load/store instruction local pointer LSLP points at the entry WI8. As a result, as in FIG. 12, the write information EX-WI for execution instruction and the write information LS-WI for load/store instruction are both asserted with respect to the register r5. Further, the read information EXIB-RI for execution instruction is asserted for the registers r4 and r5, and the read information LSIB-RI for load/store instruction is asserted for the register r0. As the write information EX-WI for execution instruction overlaps with the read information EXIB-RI for execution instruction, the execution-instruction-issue stall EX-STL is asserted. Further, this signal stalls the stage of local instruction buffer EXIB.

In the subsequent cycle, the register write information of the register r0 of the entry WI 8 which is made available by execution of the first instruction of the second loop is cleared. In addition, the write information of the fifth post-increment store instruction “mov r5, @r2+” is newly latched in the entry WI12. In addition, the write information queue pointer WIQP points at the entry WI0. The execution instruction local pointer EXLP still remains pointing at the entry WI3. The load/store instruction local pointer LSLP points at the entry WI9. As a result, as in the drawing, the write information EX-WI for execution instruction is all cleared, the write information LS-WI for load/store instruction is asserted with respect to the registers r4 and r5. Further, the read information EXIB-RI for execution instruction is asserted for the registers r4 and r5. The read information LSIB-RI for load/store instruction is asserted for the register r1. As there is no overlap in register number, the issue stalls EX-STL and LS-STL of execution instruction and load/store instruction are not asserted.

In the subsequent cycle, the register write information of the register r1 of the entry WI9, which is made available by execution of the second instruction of the second loop, is cleared. The write information queue pointer WIQP still remains pointing at the entry WI0. The execution instruction local pointer EXLP points at the entry WI10. The load/store instruction local pointer LSLP points at the entry WI12. As a result, as in FIG. 12, the write information EX-WI for execution instruction and the write information LS-WI for load/store instruction are both asserted with respect to the registers r4 and r5. Further, the read information EXIB-RI for execution instruction is asserted for the register r3, and the read information LSIB-RI for load/store instruction is asserted for the register r2. As there is no overlap in register number, the issue stalls EX-STL and LS-STL of execution instruction and load/store instruction are not asserted.

In each of the three subsequent cycles, the same action is performed as cycle three cycles before. The difference between the cycles is that the content of the write information queue WIQ is displaced by eight entries. This is not shown, however in each of further additional three cycles after that, the same process as that in the cycle six cycles before is performed. As described above, the flow dependence is managed by the write information queue WIQ, and the instruction issue is performed appropriately.

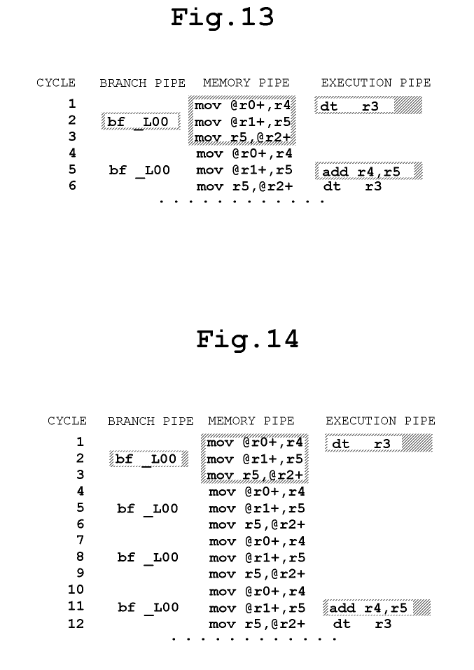

FIG. 13 exemplifies actions in connection with the loop portion of the first program run by the processor according to the embodiment of the invention.

Here, the execution cycles of the respective instructions are typified by local instruction buffer stages LSIB and EXIB or branch stage BR of the pipeline action exemplified with reference to FIG. 12. In regard to the load instruction, three stages, i.e. the address calculation stage LSA and data cache access stages DC1 and DC2, are counted in as a latency. As to the branch instruction, the branch stage BR and global instruction buffer stage GIB are counted in a latency. Therefore, the latencies of the load instruction and branch instruction are three and two, respectively. First, in the first cycle, the top load instruction “mov @r0+, r4” and the third decrement test instruction “dt r3” are executed. In the second cycle, the second load instruction “mov @r1+, r5” and the conditional branch instruction “bf _L00” at the end of the loop are executed. In the third cycle, the fifth post-increment store instruction “mov r5, @r2+” is executed. Then, in the fourth cycle, the process of the second loop is started, and the top load instruction “mov @r0+, r4” is executed. The third decrement test instruction “dt r3” has been executed in the first loop, however the third instruction is not executed because it never passes the preceding fourth add instruction “add r4, r5” of the first loop. Further, in the fifth cycle, the fourth add instruction “add r4, r5” of the first loop is executed in addition to the same action as that of the second cycle. In the sixth cycle, the third decrement test instruction “dt r3” is executed in addition to the same action as that of the third cycle. After that, actions of three cycles per loop are repeated.

FIG. 14 exemplifies the action in connection with the loop portion in case that the load latency is extended to nine from three of the example of FIG. 4.

With an increase in the load latency, execution of the fourth add instruction “add r4, r5” is delayed by six cycles in comparison to the example of FIG. 4. In parallel with this, execution of the third decrement test instruction “dt r3” of the second loop is also delayed by six cycles. With the system of the invention, it is possible to perform processes according to the out-of-order system with a different execution resource. Therefore, the delay of execution of the execution pipe does not affect other parts, and the actions of three cycles per loop are maintained. Hence, the deterioration in performance owing to the increase in load latency is relatively small. However, such actions need sophisticated branch prediction. Particularly, the conditional branch instruction is executed before hit/miss for prediction is decided and as such, the nest of branch prediction arises, which makes control more complicated.

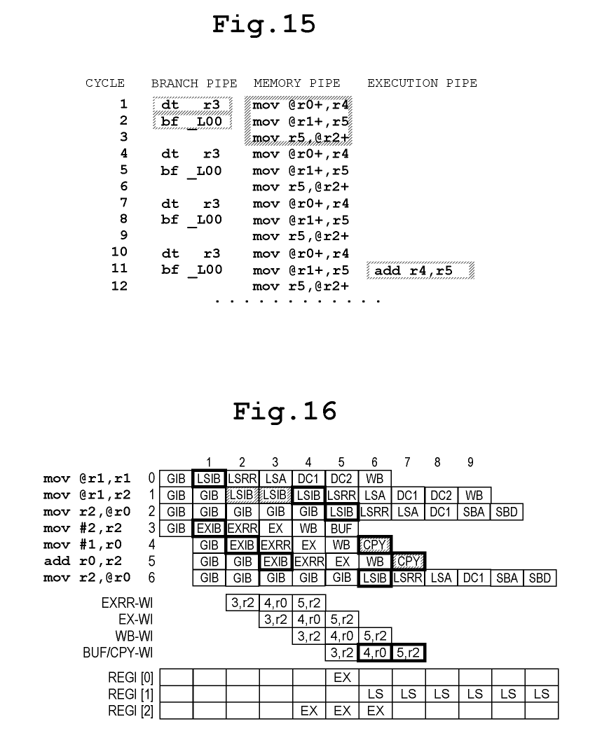

FIG. 15 shows a case that the third decrement test instruction “dt r3”, which is executed in the execution pipe in the example of FIG. 14, is executed in the branch pipe.

When the decrement test instruction is executed as shown in FIG. 15, the delay of execution of the fourth add instruction “add r4, r5” does not spread, the branch condition is fixed earlier, and thus the need for the nest of branch prediction is eliminated. It is noted that the circuit shown in FIG. 8 cannot deal with register read and write in the branch pipe, and an additional circuit is required. However, the branch instruction includes register indirect branch, and it is desired that register read and write can be handled. It is predicted that there are many programs with a low uprise frequency of the register indirect branch, which is for branching toward a long distance that is hard to reach by displacement-specified branch from the origin of the branch. The increase in cost as a result of making an arrangement so that register read and write can be handled by the branch pipe is not necessarily commensurate with the enhancement of performance.

According to this embodiment, the problems concerning antidependence and the output dependence are not posed because in-order execution is performed in the same execution resource. However, in case that appropriate processing is not performed between different sources, a trouble would occur.

FIG. 16 exemplifies a pipeline action according to this embodiment, in which antidependence and the output dependence develop.

The first load instruction “mov @r1, r1” loads data into the register r1 from a memory position which the register r1 indicates. The second load instruction “mov @r1, r2” loads data into the register r2 from a memory position which the register r1 indicates. The third store instruction “mov r2, @r0” stores the value of the register r2 in a memory position which the register r0 indicates. The fourth immediate-transfer instruction “mov #2, r2” writes two(2) into the register r2. The fifth immediate-transfer instruction “mov #1, r0” writes one(1) into the register r0. The sixth add instruction “add r0, r2” adds the value of the register r0 to the register r2. The last store instruction is the same as the third instruction.

On condition that the load/store instruction is executed with a memory pipe, and immediate-transfer and add instructions are conducted with an execution pipe, the first three instructions and the last one are executed with a memory pipe, and another three instructions including and after the fourth one are executed with the an execution pipe. At this time, the second load instruction and the fourth and sixth instructions are in the relation of output dependence. The third store instruction and the fourth and fifth immediate-transfer instructions are in the relation of antidependence. In addition, the instructions are subjected to in-order execution with a memory pipe and an execution pipe, and therefore the output dependence and antidependence never come to the surface as long as the respective local register files EXRF and LSRF are simply updated using the respective execution results. However, in case that the result of execution of one pipe is referred to by the other pipe, it is required to transfer the result of execution between the pipes, and the output dependence and antidependence can come to the surface. In the example as shown in FIG. 16, the results of execution of the fifth and sixth instructions executed with the execution pipe are used to carry out the last instruction with the memory pipe. On This account, it is required to transfer the results of execution of the fifth and sixth instructions from the execution pipe to the memory pipe. As the last instruction produces a read register information LSIB-RI in LSIB stage, it is found that transfer of the register values r0 and r2 is required in this stage. At this point of time, the LSRR stage of the memory pipe instruction preceding the last instruction has been finished, and the antidependence has been eliminated. Therefore, no problem is posed even when the execution results are transferred from the execution pipe to the memory pipe. Specifically, the fifth and sixth instructions perform write back to the local register file EXRF in the write back stage WB in the fifth and sixth cycles respectively. Thereafter, the need for transferring the value subjected to write back becomes clear at the beginning of the LSIB stage of the last instruction in the sixth cycle. Therefore, the instructions transfer the register values r0 and r2 in the copy stages CPY of the sixth and seventh cycles respectively.

The register value r2 used by the third store instruction is not present in the LSRR stage, and it cannot be read out. Thereafter, nothing is read out from the local register file LSRF, and the value is taken by means of forwarding at the time when the value is produced before the store buffer data stage SBD. On this account, even when the third store instruction cannot read the register value r2 in the LSRR stage, the value transferred from the execution pipe to the memory pipe may be written into the register r2 of the local register file LSRF of the memory pipe. As a result, with the local register file LSRF of the memory pipe, write into the register r2 by the sixth instruction is performed before write into the register r2 by the second instruction, and the output dependence comes into the surface. Hence, the second load instruction conducts no register write into the register r2, and performs only data forwarding to the third store instruction.

For the aforementioned copy, it is sufficient to add dedicated read write ports to the local register files EXRF and LSRF, or to share an existing port at times of normal read and write. In case that the port is shared and thus accesses compete for the port, it is conceivable for those skilled in the art who design data processing apparatuses including processors to exercise control so that successive access is performed while having one access waiting. Further, it is unusual that the result of execution is not used for a while. Therefore, it is often the case that copy can be performed without adding a port as long as the value is left in the buffer even after write back to the local register file. In the example shown in FIG. 16, one buffer/copy stage BUF/CPY subsequent to the write back stage WB is provided, whereby the need for a register read port for transfer is eliminated.

In typical pipeline control, write back information EXRR-WI, EX-WI and WB-WI is forced to flow toward the write back stage WB. When the subsequent instruction uses a value, if there are two or more pieces of write back information to a register of the same number, the newest value may be used. In contrast, in the pipeline control according to the invention, write back information BUF/CPY-WI of the buffer/copy stage BUF/CPY is added. Instructions are not necessarily executed successively with different pipes. Therefore, the instructions are numbered, followed by making comparisons among the instructions in their ordinal positions in the program, and identifying and selecting the value produced by the latest one of the instructions preceding an instruction to be read, in the ordinal positions in the program. In the example of FIG. 16, the numbers assigned by the write information queue WIQ are used as they are. The value of the register r2 is updated by the two instructions having instruction numbers of three and five, which is referred to by the store instruction with an instruction number of six. Therefore, the result of the add instruction with the instruction number five is transferred and used.

If the ordinal positions of the instructions in the program are reversed, the store instruction is assigned as the fifth, and the add instruction is assigned as the sixth, the value to be transferred is the result of the immediate-transfer instruction with an instruction number of three. In this case, if one additional buffer stage is prepared, a value can be left in the buffer and transferred from the buffer.

The write information queue WIQ has sixteen entries, which needs four bits to identify the entries. If the distance between an instruction to transfer a value from a buffer and an instruction to refer to the value is limited, the number of bits can be reduced. Further, when instructions executed with the same pipe are successive in the program, a common identification number can be used for the successive instructions, and therefore the limitation concerning the distance between the instructions can be eased even with the same bit number. For example, in the example shown in FIG. 16, the instructions can be divided into three groups of: the first to third ones; the fourth to sixth ones; and the seventh one, and therefore two bits is sufficient as the identification information for the seven instructions.

When having passed the buffer/copy stage BUF/CPY, write back information comes to naught, and therefore the information that only one local register file has the latest value is erased. Hence, register states are defined for the respective registers. In the example of FIG. 16, two bits of information REGI [n] (n: 0-15) is held for each register, and the following three states are recorded: all is up to date; the local register file LSRF of the memory pipe is up to date; and the local register file EXRF of the execution pipe is up to date. In FIG. 16, pieces of information about the resisters r0, r1 and r2 are shown. The blank, LS and EX represent that all is up to date, that the local register file LSRF of the memory pipe is up to date, and that the local register file EXRF of the execution pipe is up to date, respectively.

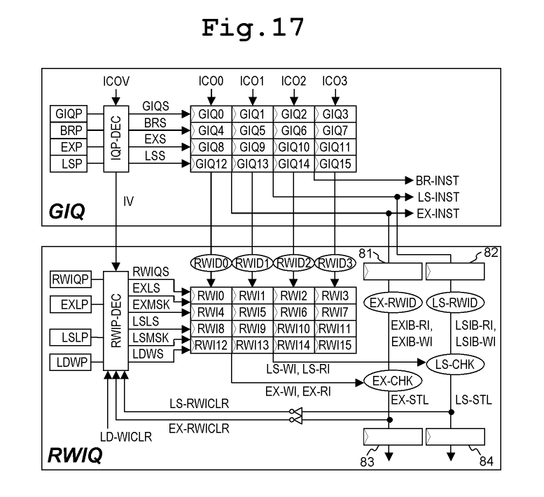

Other means for handling the relations of antidependence and the output dependence is to control so that register read and write of a preceding instruction are not passed by register write of a subsequent instruction. FIG. 17 shows an example of a read/write information queue RWIQ, which the write information queue WIQ of FIG. 8 is expanded into, and which also holds read information, whereby not only the flow dependence, but also the antidependence and the output dependence can be detected.

The read/write information queue RWIQ includes: a read-and-write-information decoder RWID0-3; read/write information entries RWI0-15 for 16 instructions; a read/write information queue pointer RWIQP which specifies a new read/write information set position; an execution instruction local pointer EXLP and a load/store instruction local pointer LSLP which specify positions of execution instruction and load/store instruction in local instruction buffer stages EXIB and LSIB; a load data write pointer LDWP which points at an instruction for loading load data to be made available subsequently; and a read/write information queue pointer decoder RWIP-DEC which decodes the pointers.

In the read/write information queue RWIQ, the read-and-write-information decoders RWID0-3 receive four instructions latched by the global instruction queue GIQ to produce register write information of the instructions, first. Then, if the validity signal IV in connection with the received instructions has been asserted, the produced register read/write information is latched in the read/write information entries RWI0-3, RWI4-7, RWI8-11 or RWI12-15 according to a read/write-information-queue-select signal RWIQS produced as a result of decode of the read/write information queue pointer RWIQP. The read/write information queue pointer RWIQP points at the oldest instruction of the instructions latched by the read/write information queue RWIQ. Therefore, when the register read/write information of four instructions is regarded as being unnecessary based on this oldest instruction and erased, empty spaces are created in the read/write information queue RWIQ and thus it becomes possible to latch read/write information in connection with new four instructions. After new read/write information has been newly latched, the read/write information queue pointer RWIQP is set forward so as to point at subsequent four entries.

In contrast, the execution instruction local pointer EXLP and the load/store instruction local pointer LSLP point at an instruction which will be executed next. From the oldest instruction to the instruction right before the instruction specified by the pointers make instructions preceding the instruction which will be executed next, which are treated as instructions targeted for check on the flow dependence, antidependence and output dependence. Then, the read/write information queue pointer decoder RWIP-DEC produces mask signals EXMSK and LSMSK for execution instruction and load/store instruction from the read/write information queue pointer RWIQP, and the execution and load/store instructions' local pointers EXLP and LSLP; the mask signals are for selecting all entries within a range targeted for the check on the flow dependence, antidependence and output dependence.

According to the mask signal EXMSK for execution instruction, the read/write information of an instruction preceding the execution instruction which the execution instruction local pointer EXLP points at is taken out of the 16 entries of the read/write information queue RWIQ to work out a logical sum, and outputs the result as read/write information EX-RI/EX-WI for execution instruction. Likewise, according to the mask signal LSMSK for load/store instruction, the read/write information of an instruction preceding the load/store instruction which the load/store instruction local pointer LSLP points at is taken out of the 16 entries of the read/write information queue RWIQ to work out a logical sum, and outputs the result as read/write information LS-RI/LS-WI for load/store instruction.

Concurrently, in the stage of global instruction buffer GIB, the execution instruction EX-INST and load/store instruction LS-INST output from the global instruction queue GIQ are latched by latches 81 and 82. In the stages of local instruction buffer LSIB and EXIB, the instructions thus latched are synchronized and input to register read/write information decoders EX-RWID and LS-RWID of execution instruction and load/store instruction to decode them. Thus, the pieces of register read/write information EXIB-RI, EXIB-WI, and LSIB-RI and LSIB-WI of execution instruction and load/store instruction are produced. Then, logical products of write information EX-WI and LS-WI, and read information EXIB-RI and LSIB-RI are worked out according to register numbers, and the resultant products are added up into logical sums with respect to all the register numbers. Thus, the respective flow dependences of execution instruction and load/store instruction are detected. Likewise, logical products of read information EX-RI and LS-RI, and write information EXIB-WI and LSIB-WI are worked out according to register numbers, and the resultant products are added up into logical sums with respect to all the register numbers. Thus, the respective antidependences of execution instruction and load/store instruction are detected. Further, logical products of write information EX-WI and LS-WI and write information EXIB-WI and LSIB-WT are worked out according to register numbers, and the resultant products are added up into logical sums with respect to all the register numbers. Thus, respective output dependences of execution instruction and load/store instruction are detected. Then, the logical sums of information on the three kinds of dependences are worked out. The resultant logical sums are used as issue stalls EX-STL and LS-STL.

As in the case of the write information queue WIQ shown in FIG. 8, on negation of such issue stalls, instructions are issued. This embodiment is based on the assumption that the operation of execution instruction and the address calculation of load/store instruction are finished in one cycle. Therefore, when an execution instruction and a load/store instruction are issued, the results can be used for instructions issued in subsequent cycles. As the check on antidependence is made unnecessary after issue, the register read information is also made unnecessary. Hence, on issue of an instruction, corresponding register read/write information in the read/write information queue RWIQ is cleared. Therefore, signals resulting from negation of the issue stalls EX-STL and LS-STL of execution instruction and load/store instruction are used as register read write information clear signals EX-RWICLR and LS-RWICLR of execution instruction and load/store instruction. On the other hand, the latency of load instruction is three and therefore the corresponding register write information is cleared after a lapse of two cycles typically. However, a lapse of three or more cycles can be required owing to e.g. cache miss before it is allowed to use load data. Hence, the corresponding register write information is cleared by inputting a load-data-register-write-information-clear signal LD-WICLR at the time when the load data is actually made available.

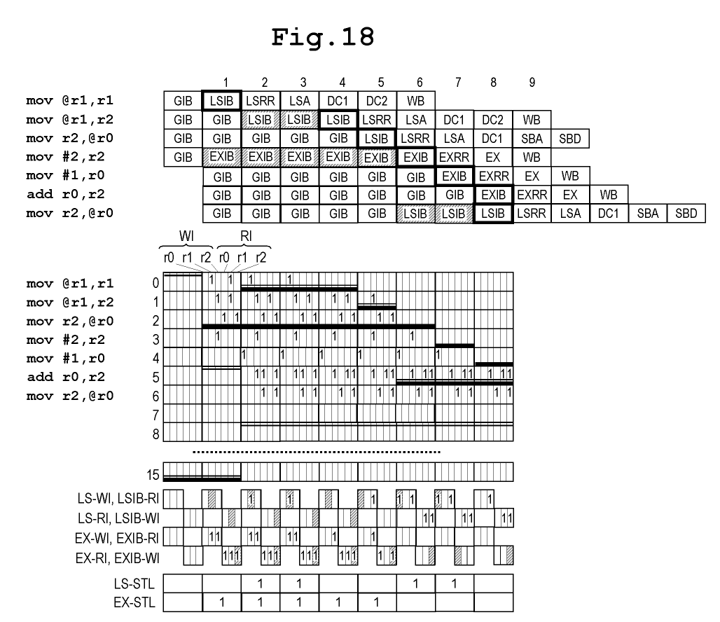

FIG. 18 exemplifies a pipeline action by the processor 10 having a read/write information queue RWIQ (see FIG. 17) in connection with the same program as that the program shown in FIG. 16.

The register read/write information has a total of 32 bits, which consists of 16 bits corresponding to 16 registers for entries in connection with read and 16 bits for entries in connection with write. In the program exemplified, only three registers r0, r1 and r3 are used and as such, the values of each cycle are shown in regard to six bits of read/write information corresponding to the three registers. As to the entries, of 16 entries, 10 entries #0 to #8 and #15 are shown. With the values of the read/write information queue RWIQ, “1” is written only in the cells corresponding to bits taking a value of one (1), and each blank represents “0”, as in the case shown in FIG. 12. Also, in regard to outputs LS-WI, LS-RI, EX-WI, and EX-RI from the read/write information queue RWIQ, only bits taking “1” are written in, and blanks represent bits of “0”. As for values of the register read/write information EXIB-RI, EXIB-WI, LSIB-RI and SIB-WI of execution instruction and load/store instruction, only when the values have “1”, the corresponding cells are hatched, and the cells corresponding to “0” remain blank. Hence, in case that the flow dependence and antidependence develop, the cell of “1” overlaps with the hatched cell locationally.

In the second and third cycles, an overlap of write information LS-WI and read information LSIB-RI arises at the register r1, which shows that the first and second instructions are flow-dependent. Consequently, issue of the second instruction is stalled for two cycles. Further, in the second to fifth cycles, an overlap of read information EX-RI and write information EXIB-WI occurs at the register r2, which shows that the third and fourth instructions are antidependent. Thus, issue of the fourth instruction is stalled for five cycles. As to the output dependence, the values of EX-WI and EXIB-WI of the resister r2 take one(1) in the second to fifth cycles concurrently, which shows that the second and fourth instructions are output-dependent, though cells prepared for EX-WI and EXIB-WI are not coincident with each other and therefore, the filled cells never overlap. In other words, the fourth instruction is stalled owing to not only the antidependence but also its output dependence. Further, in the sixth and seventh cycles, an overlap of LS-WI and LSIB-RI of the resister r0 occurs, which shows that the fifth and seventh instructions are flow-dependent. Consequently, issue of the seventh instruction is stalled for two cycles.

As described here, the circuit scale of a dependent-relation-checking mechanism is enlarged, and the number of execution cycles is also increased further in comparison to the system as described above. The dependent relations can be checked in a unified manner. The need for managing the place where the latest register value is held is eliminated.

In contrast, the above system has the advantage that a small circuit scale and a high performance can be achieved. In addition, the system is based on local register write, and can suppress the register write to other pipe to a minimum, which is suitable to lower the electric power.

While the invention made by the inventor has been described above specifically, the invention is not so limited. It is needless to say that various modifications and changes may be made without departing from the subject matter hereof.

For instance, in the above embodiment, control is performed so that register write of a preceding instruction is not passed by register write of a subsequent instruction. However, control may be exercised so as to inhibit register write of a preceding instruction when register write of the preceding instruction is passed by register write of a subsequent instruction targeting the same register. Doing such control, the information held by a register can be prevented from being damaged. Therefore, the consistency between execution results of instructions in the output-dependent relation can be maintained.

In the above description, the invention chiefly made by the inventor has been described focusing on a processor which belongs to an applicable field forming a background of the invention. However, the invention is not so limited. The invention is applicable to data processing apparatuses which perform data processing.

The invention can be applied on condition that at least two execution resources are contained.

What is claimed is:

1. A data processing apparatus comprising:
execution resources, each enabling a predetermined process for executing an instruction,
wherein the execution resources enable a pipeline process,
each execution resource treats instructions according to an in-order system following an order of flow of the instructions in case that the execution resource is in charge of the instructions, and
each execution resource treats instructions according to an out-of-order system regardless of order of flow of the instructions in case that the instructions are treated by different execution resources.

2. The data processing apparatus according to claim 1, further comprising:
an instruction fetch unit operable to fetch an instruction,
wherein the instruction fetch unit includes
a global instruction queue operable to latch the fetched instruction, and
an information queue operable to manage register write information produced from the instruction latched by the global instruction queue, and to check flow dependence as a hazard by a preceding instruction, based on register write information of a preceding instruction of a scope differing for each execution resource.

3. The data processing apparatus according to claim 2,
wherein the information queue exercises control so that a preceding instruction of register read is never passed by a subsequent instruction of register write.

4. The data processing apparatus according to claim 1,
wherein a local register file is arranged for each of the execution resources.

5. The data processing apparatus according to claim 4,
wherein register write is performed only on the local register file corresponding to the execution resource operable to read out a written value.

6. The data processing apparatus according to claim 4,
wherein execution resources include an execution unit enabling data processing, and a load-store unit enabling data load and store based on the instruction,
the local register files include a local register file for execution instruction arranged in the execution unit, and a local register file for load/store instruction arranged in the load-store unit, whereby locality of register read is ensured.

7. The data processing apparatus according to claim 2,
wherein the information queue is controlled so that register write of a preceding instruction is never passed by that of a subsequent instruction.

8. The data processing apparatus according to claim 2,
wherein in case that register write of a preceding instruction targeting a register is passed by register write of a subsequent instruction targeting the same register, register write of the preceding instruction is inhibited by the information queue.
